(19) United States
(12) Patent Application Publication
(10) Pub. No.: US 2008/0073937 A1
(43) Pub. Date: Mar. 27, 2008

(54) Trailer with access hatch

(75) Inventors: Loran A. Circle, Hamburg, NY (US); Anton Gerich, Gilead, OH (US); Dennis Lutz, Galion, OH (US)

Correspondence Address: SIMPSON & SIMPSON, PLLC, 5555 MAIN STREET, WILLIAMSVILLE, NY, 14221-5406, US

(73) Assignee: Loran A. CIRCLE, Hamburg, NY (US)

(21) Appl. No.: 11/526,332

(22) Filed: Sep. 25, 2006

(51) Int. Cl. B62D 33/04

(52) U.S. Cl. 296/182.1

(57) ABSTRACT

An enclosed trailer with a base, with a shell attached to the base wherein the shell forms a front wall and opposing side walls of the trailer. A rear door is hingeably connected to the base and the rear door forms the rear wall of the trailer when in a vertical position and forms a ramp when in a roughly horizontal position. A roof is hingeably connected to the trailer and the roof can elevate above the trailer in an open position, and lower to abut the trailer walls in a closed position. The roof can have a lifting element to assist in elevating the roof. A hatch is hingeably connected to the trailer and is positioned on the front wall. A lifting element can be attached to the hatch and the trailer to assist in the opening and closing of the hatch.

### FIELD OF THE INVENTION

The invention relates generally to a trailer, and, more particularly, to a fully covered trailer with a ramp, a roof that can be elevated, and a front hatch that provides access to the interior compartment of the trailer.

### BACKGROUND OF THE INVENTION

Trailers for towing small motorized vehicles like motorcycles and personal watercraft, and the like, are known in the art. Conventional enclosed trailers have a shell that encloses the interior compartment of the trailer to protect the stowed cargo from the elements. A difficulty posed by these covered trailers is that they provide very little room for access to the interior of the trailer. Access to the interior compartment of the trailer is important to properly secure the vehicles to the trailer. However, the outer shell of covered trailers can prevent access and make the securing of cargo like motorcycles difficult and time consuming.

Some trailer styles have utilized a raising roof feature to enable access to the interior of the covered trailer. This feature is adequate in instances when the vehicles are smaller, like personal watercraft, which can be launched in the water, but loading and unloading is still difficult. Larger and heavier vehicles require access to the trailer from various angles to properly secure the vehicle inside the trailer, and successfully remove the vehicle from the trailer.

Conventional covered trailers only provide access from the rear of the trailer and access through the front of the vehicle is not an option. Due to this traditional positioning of a door only at the rear of the trailer, straps, tie downs, and cleats in the front of the trailers are inaccessible or cumbersome to reach. Another shortcoming of trailers with only rear accessibility is that the space in the front of the trailer is underutilized or not used at all. Conventional trailers offer a user an opening to enter the rear of the trailer, but trailers that enable a user to enter and exit the trailer through both ends of the trailer are not available.

Thus, there is a need for a covered trailer that can provide broad access to the rear of the trailer and access to the front of the trailer to enable loading and unloading of cargo.

### SUMMARY OF THE INVENTION

The invention broadly comprises an enclosed trailer with a base, a shell attached to the base wherein the shell forms a front wall and opposing side walls of the trailer. A rear door is hingeably connected to the base and the rear door forms the rear wall of the trailer when in a vertical position and forms a ramp when in a roughly horizontal position. A roof is hingeably connected to the shell and the roof can elevate above the shell in an open position, and lower to abut the shell in a closed position. The roof can have a lifting element to assist in elevating the roof. A hatch is hingeably connected to the trailer and is positioned on the front wall. A lifting element can be attached to the hatch and the trailer to assist in the opening and closing of the hatch.

In some aspects, the rear door further comprises a retention element that prevents the ramp from extending beyond a point slightly past parallel with the base. The rear door can further comprise a supplemental ramp structure pivotably attached to the rear door distal to the base. The rear door can also have a latching mechanism to secure the ramp closed. The roof can include a latching mechanism to secure the roof closed. The trailer can also have a latching mechanism to secure both the rear door and the roof closed, where the latching mechanism has latching arms extending to both sides of the rear door and a latching arm extending to the top of the rear door that engage the catches on the roof and the trailer walls.

In some embodiments, the trailer has retaining elements that are operatively arranged to secure cargo inside said trailer. The retaining elements can be positioned in the front and rear of the trailer. The hatch can be sized and positioned to permit access through the front wall to the interior of the trailer. The trailer can fit at least one motorized vehicles inside said. The hatch can also be positioned and sized to permit ingress or egress from the trailer through the front wall of the trailer.

The invention further broadly comprises an enclosed trailer with an upper shell fixed to a base where the shell has a front and opposing side walls and a front and a rear opening. A door is attached to the base by a hinge proximate the rear opening and the door is operatively arranged to form a wall that blocks the rear opening when in an upright position, and operatively arranged to form a ramp in a down position. A roof is hingeably attached to the front wall of the shell, and a hatch is disposed on the front wall in a manner that the hatch is positioned over said front opening.

The roof can further comprise a lifting element that assists in holding the roof in an elevated position. The trailer can also include a sealing element that seals the roof and the upper shell to each other, when in a closed position, to resist moisture from entering the trailer. The trailer can also include a sealing element that seals the ramp to the side walls of the upper shell, when in a closed position, to resist moisture from entering the trailer.

It is a general object of the present invention to provide a trailer with a roof, ramp, and hatch that can provide access to the interior trailer to facilitate loading and unloading of cargo.

It is another object of the present invention to provide trailer with a roof that can be elevated, a hatch that provide access to the interior of the trailer, and ramp that can function as a rear door or a ramp for the trailer.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a trailer of the present invention;

FIG. 2 is a side elevational view of the trailer shown in FIG. 1;

FIG. 3 is a rear elevational view of the trailer shown in FIG. 1;

FIG. 4 is a front perspective view of the trailer shown in FIG. 1;

FIG. 5 is another rear elevational view of the trailer shown in FIG. 1;

FIG. 6 is another front perspective view of the trailer shown in FIG. 1;

FIG. 7 is a perspective view of a trailer of the present invention;

FIG. 8 is perspective view of the trailer shown in FIG. 7; and,

FIG. 9 is a cross-sectional view of the trailer in FIG. 2, taken generally along line 5-5 in FIG. 2.

### DETAILED DESCRIPTION OF THE PREFERRED EMBODIMENT

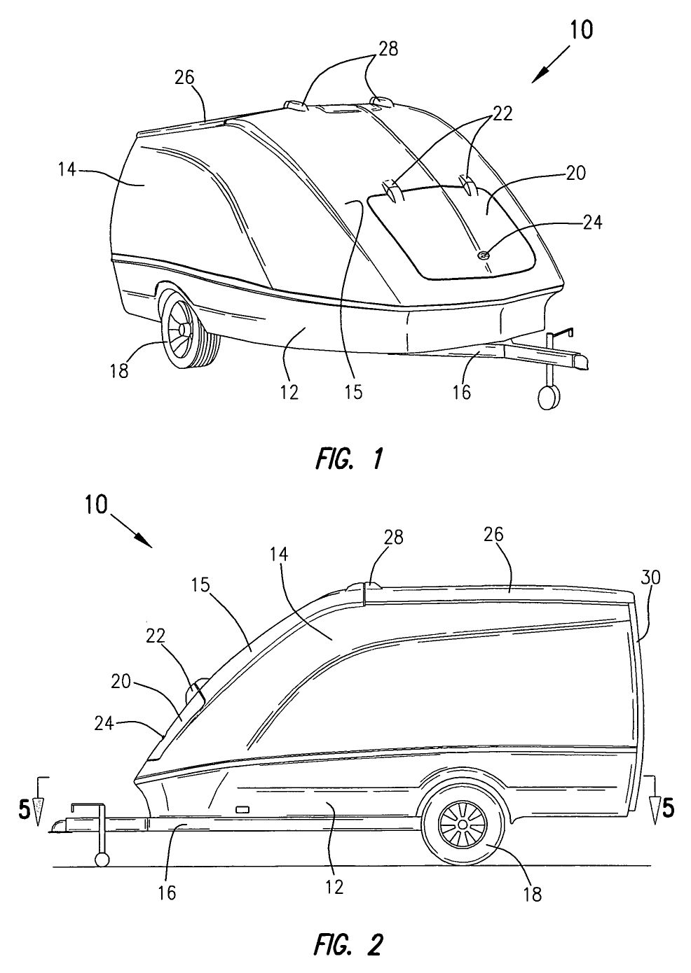

At the outset, it should be appreciated that like drawing numbers on different drawing views identify identical structural elements of the invention. While the present invention is described with respect to what is presently considered to be the preferred embodiments, it is understood that the invention is not limited to the disclosed embodiments. In the description below, the terms “top”, “bottom”, “upper”, “lower”, “front”, “back”, “rear”, “left”, “right”, and their derivatives, should be interpreted from the perspective of one viewing the invention shown in FIG. 1.

Furthermore, it is understood that this invention is not limited to the particular methodology, materials and modifications described and as such may, of course, vary. It is also understood that the terminology used herein is for the purpose of describing particular embodiments only, and is not intended to limit the scope of the present invention.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

In accordance with the present invention and with reference to FIG. 1, a perspective view of trailer 10 is provided with base 12 having side walls 14 and front wall 15 attached. Base 12, side walls 14 and front walls 15 can be separate elements that are attached together using any attachment method known in the art, or base 12, side walls 14 and front wall 15 can be formed as a single integral unit. The material best suited for constructing base 12, side walls 14 and front wall 15 of trailer 10 is fiberglass or another lightweight synthetic material, but other materials such as aluminum or another metal could be used as well.

Base 12 is attached to a frame 16 that supplies a rigid support to base 12 and supplies an attachment location for wheels 18. Frame 16 preferably includes a trailer hitch to enable trailer 10 to be hauled by another vehicle. In the embodiment shown, only two wheels are shown, but additional wheels could be used. The size and tread design of the wheels is also variable.

Hatch 20 is positioned on front wall 15 with a hinged connection using hinges 22. Hinges 22 can be spring loaded and aid in the opening and closing of hatch 20. A streamline hinge 22 is shown, but hinge 22 can be various shapes and sizes. Alternatively, a single hinge 22 can be used to hingeably connect hatch 20 to trailer 10. In the embodiment shown, hinges 22 are arranged to enable hatch 20 to open upward. It should be understood that hatch 20 can also be hingeably connected to front wall 15 in such a manner that hatch 20 opens to either side, or downward. Hingeably connected is defined as a connection that enables one or both elements that are connected to each other to swing freely, yet remain securely connected to each other. A hinged connection permits an element to have one side or edge hingeably connected to a structure with the other sections of the element unconnected. This single point hinged connection enables the element to swing open while still remaining hingeably connected to the structure at the hinged connection point.

Latch 24 can be positioned at various locations on hatch 20 to secure the hatch closed. Roof 26 is hingeably connected to trailer 10 by hinges 28, particularly to the shell of the trailer formed by base 12, side walls 14 and front wall 15. Hinges 28 can be spring loaded and aid in the opening and closing of roof 26. A streamline hinge 28 is shown, but hinge 28 can be various shapes and sizes. Alternatively, a single hinge 28 can be used to hingeably connect roof 26 to trailer 10.

FIG. 2 is a side elevational view of trailer 10.

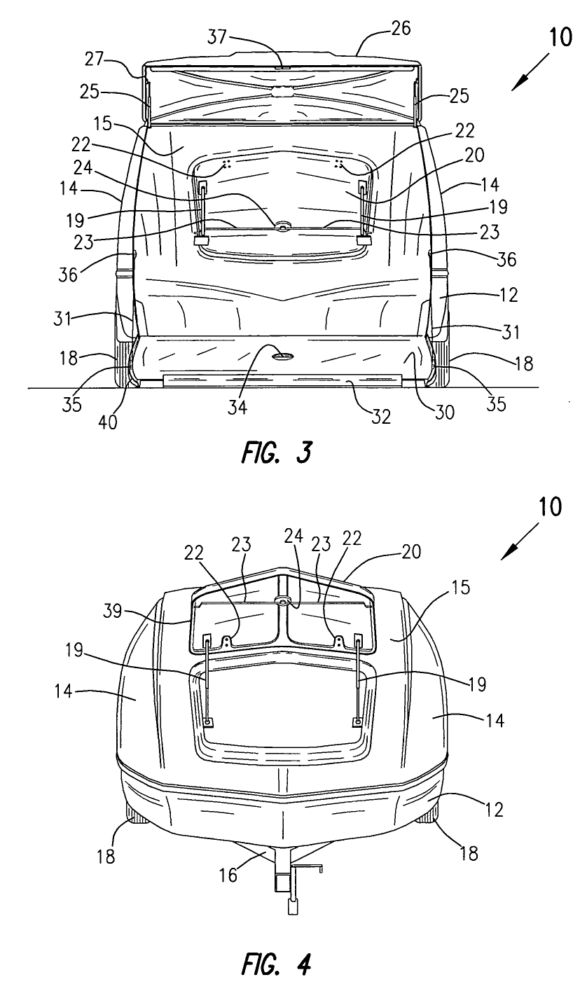

FIG. 3 is a rear elevational view of trailer 10 with rear door 30 open and roof 26 open. In this open position roof 26 exposes seal 27 around the perimeter of roof 26. When roof 26 is closed, seal 27 can be positioned and shaped to seal upon walls 14 and rear door 30 to resist moisture from entering the hull of trailer 10. Seal 27 can also be position on trailer 10 around the edge of base walls 14 (not shown).

The interior compartment of trailer 10 is visible in this view showing the interior surface of hatch 20 and its associated elements. To open hatch 20 an exterior portion of latch 24 positioned on the exterior surface of hatch 20 is rotated to disengage latch arms 23 from front wall 15. Latch 24 and its latch arms 23, which interact with the interior of wall 15, demonstrate one possible latching system that could be used to secure hatch 20 when closed. However, another latching system could replace the system shown.

Roof 26 is shown in an elevated position using lifting elements 25 to assist in holding the roof in an elevated position. Conventional pneumatically pressurized lifting cylinders, known in the art, are one possible type of lifting element 25. Roof 26 is hingeably connected to trailer 10 proximate front wall 15 by hinges 28, which facilitates the swinging upward of the rear end of roof 26. This hinged connection creates additional head room in trailer 10 to permit a user to more easily access the interior compartment of trailer 10. This enables a user to access areas not normally accessible in typical trailers, enabling quicker and easier loading and unloading of cargo.

Rear door 30 functions as a ramp in the down position, which enables cargo to be loaded and unloaded. Rear door 30 functions as a rear door to seal the cabin of the trailer 100 when closed, i.e., sung into a vertical position. Support lines 31 attached to the outer edge of rear door 30 and the rear edge of walls 14 can be included to add support to prevent over pivoting of rear door 30, which could damage the hinges (not shown) that can be used to attach rear door 30. A supplemental ramp 32 can be attached to the end of rear door 30 with hinges (not shown) or another attachment means known in the art. Along the interior edge of rear door 30, seal 40 can be attached as a means to seal out moisture from the interior compartment of trailer 10. Seal 40 can also be position on trailer 10 around the edge of base 12 and walls 14 (not shown).

Latch 34 can be used to secure rear door 30 closed with latching members 35 that interact with catches 36 on the rear end of side walls 14. Latch 34 can include latching members that interact with catch 37 in the rear end of roof 26 (not shown) and with catches 36 in side walls 14 simultaneously. In this way latch 34 can secure both rear door 30 and roof 26 closed by having a closed position that causes interaction with catches 36 and 37 simultaneously. Alternatively, another latching system could be implemented.

FIG. 4 is a front perspective view of trailer 10 with hatch 20 open. Hatch 20 can rest inside a recess in front wall 15 to seal the opening the hatch covers. In some aspects, seal 39 can be installed around the perimeter of hatch 20 and used to seal moisture out of the interior compartment of trailer 10. Seal 39 can be positioned on hatch 20 or on trailer 10 around the opening in front wall 15 (not shown). Seal 39 is compressed when hatch 20 is closed to seal the opening.

Hatch 20 can include lifting elements 19 to assist in the opening and closing of the hatch. Hatch 20 is positioned to enable a user to access the interior compartment of trailer 10 from the outside. Alternatively, a user could enter trailer 10 and exit trailer 10 through hatch 20. Lifting elements 19 would be beneficial to aid a user in entering and exiting trailer 10 without difficulty. Conventional pneumatically pressurized lifting cylinders, known in the art, are one possible type of lifting element 19.

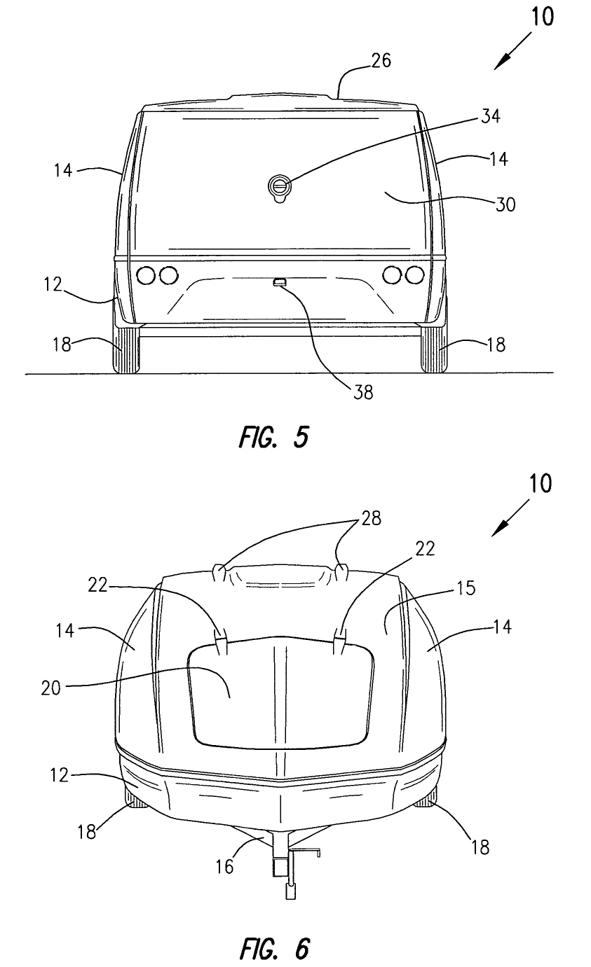

FIG. 5 is a rear elevational view of trailer 10 with roof 26 and rear door 30 closed. Latch 34 is shown centered on the rear of door 30, but latch 34 could be repositioned. Rear door 30 can be secured closed using latch 34 designed to operate latch arms 35. A portion of latch arms 35 is visible on both sides of rear door 30. Optionally, a third latch arm (not shown) can be positioned on the top of rear door 30. Latch arms 35 are positioned and designed to engage catches 36 on both sides of the rear of side walls 14 when latch 34 is rotated. The third latch arm can be positioned to engage catch 37 positioned on the end of roof 26 that is distal to hinge 28. Action of latch 34 can then operate latch arms 35 and the third latch to open, or close, rear door 30 and roof 26. Alternatively, latch 34 can be oriented to operate only latch arms 35 and another separate locking mechanism known in the art can be used to secure roof 26 closed.

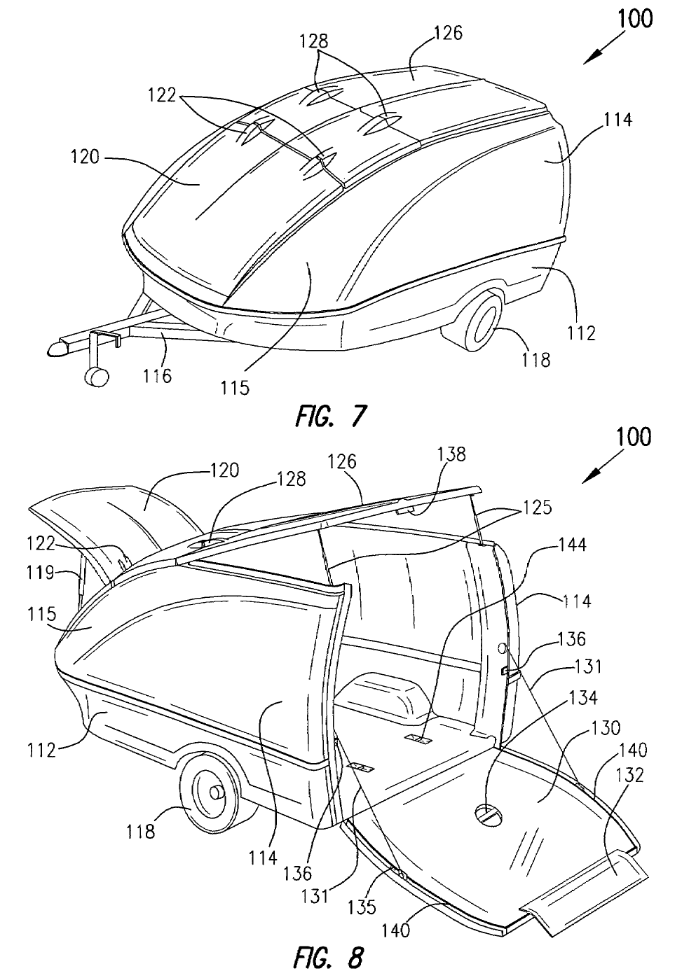

FIG. 6 is a front perspective view of trailer 10 with hatch 20 closed. In some aspects, hatch 20 is positioned to be flush with front wall 15 when the hatch is closed. Hinges 22 can also be designed to be flush or at least molded into front walls 15 to provide a surface with less wind resistance. The combination of hatch 20, roof 26 and rear door 30 provide the accessibility to load cargo on trailer 10 from the rear or front of trailer 10. Raising roof 26 provides greater head clearance. Rear door 30 in the lowered position enables cargo or vehicles to be rolled into trailer 10. Hatch 20 enables a user to access cargo in the interior of the compartment without opening rear door 30. Hatch 20 also enables a user to enter or exit trailer 10 through front wall 15 after securing cargo inside the trailer.

FIG. 7 is a perspective view of a trailer 100, a variation of trailer 10. Trailer 100 has a base 112 with side walls 114 and front wall 115 attached. Side walls 114 are on opposing sides of base 112 and can secured to base 112 or be integral to base 112. Front wall 115 can be secured to side walls 114 and base 112 or be integral to base 112 and side walls 114, forming a solid shell or hull. If base 112, side walls 114 and front wall 115 are secured as separate pieces any securing means known in the art will suffice to secure the separate segments together. Base 112, side walls 114 and front wall 115 can be made from metal, fiberglass or any other suitable material. The material best suited for constructing base 112, side walls 114 and front wall 115 of trailer 100 is fiberglass or another lightweight synthetic material, but other materials such as aluminum or another metal could be used as well.

Base 112 is attached to a frame 116 that supplies a rigid support to base 112 and supplies an attachment location for wheels 118. Frame 116 preferably includes a trailer hitch to enable trailer 100 to be hauled by another vehicle. In the embodiment shown, only two wheels are shown, but additional wheels could be used. The size and tread design of the wheels is also variable.

Hatch 120 on front wall 115, is shown slightly larger than hatch 20 providing greater clearance for the ingress and egress of cargo or users to enter the trailer 100 through front wall 115. The larger hatch also provides clearance for an individual to enter or exit trailer 100. Hatch 120 is hingeably connected to trailer 100 proximate front wall 115 by hinges 122, which can be molded into front wall 115. In the embodiment shown, hinges 122 are arranged to enable hatch 120 to open upward. It should be understood that hatch 120 can also be hingeably connected to front wall 115 in such a manner that hatch 120 opens to either side, or downward.

Hinges 122 can be spring loaded and aid in the opening and closing of hatch 120. A streamline hinge 122 is shown, but hinge 122 can be various shapes and sizes. Alternatively, a single hinge 122 can be used to hingeably connect hatch 120 to trailer 100. By providing a hatch at the front of trailer 100, which is positioned and sized to enable a person to enter the interior of trailer 100, the full capacity of the trailer can be utilized. The access provide by hatch 120 also enables a user to better secure the cargo to be hauled, which is an advance in safety of previous trailers since cargo can be secured more securely. The variance in size and positioning of hatches 120 and 20 shown in the figures indicates the understanding that hatches of the present invention can be various sizes, and can be positioned at various points on the trailer.

Roof 126 is hingeably attached to trailer 100 to the shell of the trailer formed by base 112, side walls 114, and front wall 115, proximate the top of front wall 115, by hinges 128. Hinges 128 can be spring loaded and aid in the opening and closing of roof 126. A streamline hinge 128 is shown, but hinge 128 can be various shapes and sizes. Alternatively, a single hinge 128 can be used to hingeably connect roof 126 to trailer 100.

FIG. 8 is a perspective view of trailer 100 with hatch 120, roof 126, and rear door 130 open. Front hatch 120, positioned on front wall 115, and is positioned to cover a hole in front wall 115 that is provided as an access point for trailer 100. Hatch 120 is shown in the up position held in place by lifting members 119. Conventional pneumatically pressurized lifting cylinders, known in the art, are one possible type of lifting members 119. Lifting members 119 are attached at one end to the interior of hatch 120 proximate the edge of the hatch and at the other end of lifting member 119 proximate an interior edge of a hole in front wall 115. A seal (not shown) can be attached to the perimeter of roof hatch 120, or on the surface the hatch contacts when it is closed, to seal moisture out of the trailer interior when the hatch is closed.

Roof 126 is hingeably connected to trailer 100 by hinges 128 at one end of roof 126 to enable more accessibility to the trailer. Roof 126 is shown in the up position held in place by lifting members 125. Conventional pneumatically pressurized lifting cylinders, known in the art, are one possible type of lifting member 125. Lifting members 125 are attached at one end to the interior of roof 126 proximate the end of the roof and the other end of lifting member 125 proximate the top edge of side wall 114. A seal (not shown) can be attached to the perimeter of roof 126, or the surface the roof contacts when it is closed, to seal moisture out of the trailer interior when the roof is closed.

Rear door 130 is hingeably attached to trailer 100 to enable the trailer door to function as a ramp when open (as shown in FIG. 8), and function a rear door to seal the cabin of the trailer 100 when closed, i.e., sung into a vertical position. Support lines 131 attached to the outer edge of rear door 130 and the rear edge of walls 114 can be included to add support to prevent over pivoting of rear door 130, which could damage the hinges (not shown) that attach rear door 130. A supplemental ramp 132 can also be hingeably connected to the end of rear door 130, with hinges (not shown) or another attachment means known in the art, distal to the hinged connection to the trailer. Seal 140 can be attached along the interior edge of rear door 130, as a means to seal out moisture from the interior compartment of trailer 100. Seal 140 can also be attached to the edge of base 112 and side wall 114 that would contact door 130 when it is closed (not shown).

Rear door 130 can be secured closed using latch 134 designed to operate latch arms 135 that are on both sides of rear door 130, and optionally a third latch arm (not shown) at the top of rear door 130. Only a portion of latch arms 135 are shown, and the interior of door 130 houses arms 135. Latch arms 135 are positioned and designed to engage catches 136 on both sides of the rear of side walls 114. The third latch arm can be positioned to engage catch 138 positioned on the end of roof 126 that is distal to hinge 128. Action of latch 134 can then operate latch arms 135 and the third latch to open, or close, rear door 130 and roof 126. Alternatively, latch 134 can be oriented to operate only latch arms 135 and another locking mechanism known in the art can be used to secure roof 126 closed.

The combination of hatch 120, roof 126 and rear door 130 provide the accessibility to load cargo on trailer 100 from the rear or front of trailer 100. Raising roof 126 provides greater head clearance. Rear door 130 in the lowered position enables cargo or vehicles to be rolled into trailer 100. Hatch 120 enables a user to access cargo in the interior of the compartment without opening rear door 130. Hatch 120 also enables a user to enter or exit trailer 100 through front wall 115 after securing cargo inside the trailer.

Visible on the floor of trailer 100 are cleats 144 or retaining elements which are positioned to act as points to secure or tie down cargo inside the interior compartment of trailer 100. The cargo to be carried within trailer 100 can be various items, but in some aspects, the cargo is a motorcycle. In some aspects, to accommodate the transport of motorcycles a cleat 144 is placed on each side of the proximate location that a motorcycle tire would be located. If a motorcycle is being transported, eight cleats 144 can be placed on the floor of trailer 100 with a cleat placed on each side of the proximate location of the front and rear tire of the vehicle being hauled. In some aspects, four cleats 144 are placed on the floor of trailer 100 if a single motorized vehicle is to be hauled in trailer 100. Thus, a cleat is placed on both sides of a vehicle being hauled proximate a location at the front and rear tires. However, cleats 144 can be placed at various locations on the floor of trailer 100, and the number of cleats 144 can be increased or decreased from the preferred number indicated. Straps or ropes (not shown) can be used in conjunction with cleats 144 to secure cargo or vehicles inside trailer 100.

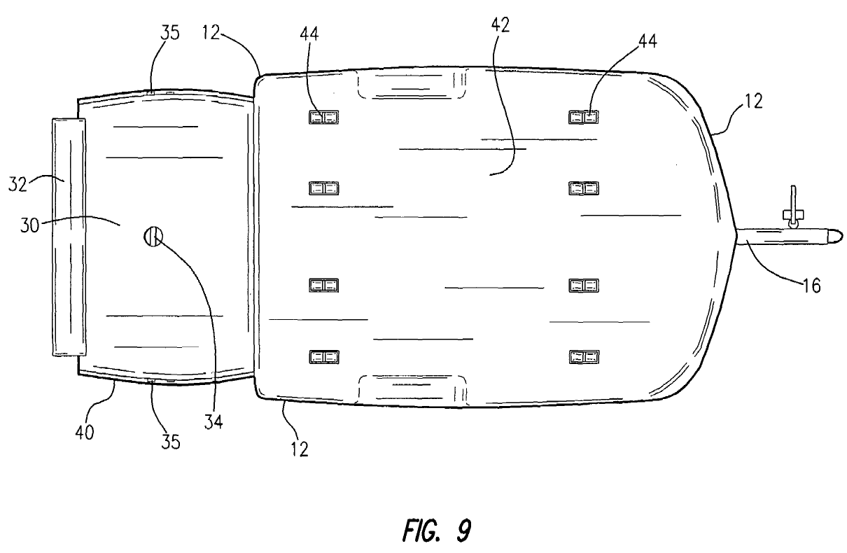

FIG. 9 is a cross-sectional view of the trailer 10, taken generally along line 5-5 shown in FIG. 2. Evident in this view are cleats 44 or retaining elements positioned on the floor of trailer 10. Cleats 44 are positioned to act as points to secure or tie down cargo inside the interior compartment of trailer 10. The cargo to be carried with trailer 100 can be various items, but in some aspects the cargo is a motorcycle, or multiple motorcycles. In some aspects to accommodate the transport of a motorcycle a cleat 44 is placed on each side of the motorcycle proximate a location that a motorcycle tire would be located. If two motorcycles are being transported, eight cleats 44 are placed on the floor of trailer 10 with a cleat placed on each side of the proximate location of the fronts and rear tire of the vehicle being hauled. However, cleats 44 can be placed at various locations on the floor of trailer 10, and the number of cleats 44 can be increased or decreased from the preferred number indicated. Straps or ropes (not shown) can be used in conjuction with cleats 44 to secure cargo or vehicles inside trailer 10.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

1. A trailer, comprising:
a base;
a shell attached to said base, wherein said shell forms a front wall and opposing side walls of said trailer;
a rear door hingeably connected to said base, wherein said rear door forms a ramp when in a lowered position;
a roof hingeably connected to said shell wherein said roof can elevate above said shell in an open position, and lower to abut said shell in a closed position; and,
a hatch hingeably connected to said trailer positioned on said front wall, wherein said hatch can be opened and closed.

2. The trailer of claim 1, wherein said rear door further comprises a retention element that prevents said rear door from extending beyond a point slightly past parallel with said base.

3. The trailer of claim 2, wherein said rear door further comprises a supplemental ramp hingeably attached to said rear door distal to said base.

4. The trailer of claim 1, further comprising a latching mechanism to secure said rear door closed.

5. The trailer of claim 4, further comprising a latching mechanism to secure said roof closed.

6. The trailer of claim 1, further comprising a latching mechanism to secure both said rear door and said roof closed, wherein said latching mechanism has latching arms extending to both sides of said rear door and a latching arm extending to the top of said rear door, wherein each latching arm has a segment that engages catches on said roof and said trailer walls.

7. The trailer of claim 1, further comprising retaining elements operatively arranged to secure cargo inside said trailer.

8. The trailer of claim 1, wherein said hatch is sized and positioned to permit access through said front wall to the interior of said trailer.

9. The trailer of claim 1, wherein said hatch is positioned and sized to permit ingress or egress from said trailer through said front wall.

10. The trailer of claim 1, further comprising a lifting element attached to said hatch and said trailer to assist in opening and closing of said hatch.

11. The trailer of claim 1, wherein said trailer can accommodate at least one motorized vehicle.

12. An enclosed trailer, comprising:
an upper shell fixed to a base, wherein said shell has a front and opposing side walls and a front and a rear opening;
a door attached to said base by a hinge proximate said rear opening, and operatively arranged to form a wall that blocks said rear opening when in an upright position, and operatively arranged to form a ramp in a down position;
a roof that is hingeably attached to said front wall of said shell; and, a hatch disposed on said front wall, wherein said hatch is hingeably attached to said front wall over said front opening.

13. The trailer of claim 12, wherein said hatch is positioned and sized to provide entry to the interior of said trailer to permit loading and unloading of cargo.

14. The trailer of claim 12, further comprising securing elements operatively arranged to secure cargo inside said trailer.

15. The trailer of claim 14, wherein said securing elements are positioned in the front and rear of said trailer.

16. The trailer of claim 12, wherein said roof further comprises a lifting element.

17. The trailer of claim 12, wherein said trailer has a sealing element that seals said roof and said upper shell to each other, when in a closed position, to resist moisture from entering said trailer.

18. The trailer of claim 12, wherein said trailer has a sealing element that seals said door to said side walls of said upper shell, when in a closed position, to resist moisture from entering said trailer.

19. The trailer of claim 12, wherein said trailer can accommodate at least one motorized vehicle.
